(19) United States
(12) Patent Application Publication
(10) Pub. No.: US 2005/0213586 A1
(43) Pub. Date: Sep. 29, 2005

(54) System and method to increase network throughput

(76) Inventors: David Cyganski, Holden, MA (US); David Holl JR., Worcester, MA (US); James M. McGrath, Marlborough, MA (US); Roy E. Johnson, Sudbury, MA (US); Michel Guaveia, St. Petersburg, FL (US); Pavan K. Reddy, Worcester, MA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/051,546

(22) Filed: Feb. 4, 2005

Related U.S. Application Data
(60) Provisional application No. 60/541,965, filed on Feb. 5, 2004.

(51) Int. Cl. H04L 12/28

(52) U.S. Cl. 370/395.41

(57) ABSTRACT

Data flows in a network are managed by dynamically determining bandwidth usage and available bandwidth for IP-ABR service data flows and dynamically allocating a portion of the available bandwidth to the IP-ABR data flows. Respective bandwidth requests from network hosts are received and an optimal window size for a sender host is determined based upon bandwidth allocated for the data flow and a round trip time of a segment to provide self-pacing of the data flow.

### CROSS REFERENCE TO RELATED APPLICATIONS

The present application claims the benefit of U.S. Provisional Patent Application No. 60/541,965, filed on Feb. 5, 2004, which is incorporated herein by reference.

### STATEMENT REGARDING FEDERALLY SPONSORED RESEARCH

Not Applicable.

### FIELD OF THE INVENTION

The present invention relates generally to communication networks and, more particularly, to systems and methods for transferring data in communication networks.

### BACKGROUND OF THE INVENTION

As is known in the art, there are a wide variety of protocols for facilitating the exchange of data in communication networks. The protocols set forth the rules under which senders, receivers and network switching devices, e.g., routers, transmit, receive and relay information throughout the network. The particular protocol used may be selected to meet the needs of a particular application. One common protocol is the Internet Protocol (IP).

In IP networks, at present the Transmission Control Protocol (TCP) is the most commonly used data transport protocol. TCP was designed to provide service that is Connection Oriented. IP is not connection oriented and TCP provides a connection-oriented service that is relatively reliable. TCP includes an Automatic Repeat request (ARQ) scheme to recover from packet loss or corruption and a congestion control scheme to prevent congestion collapses on the Internet. TCP can prevent congestion collapses by dynamically adjusting flow rates to relieve network congestion. Existing TCP congestion control schemes include exponential RTO backoff, Karns algorithm, slow start, congestion avoidance, fast retransmit, and fast recovery.

A best-effort (BE) application typically requires a connection-oriented, reliable protocol that allows one to send and receive as little as one byte at a time, similar to streaming file input and output. All bytes are guaranteed to be delivered in order to the destination, and the application is not exposed to the packet nature of the underlying network. On the Internet, the Transmission Control Protocol (TCP) is the most widely used protocol for BE traffic. TCP is unsuitable for most Constant Bit Rate (CBR) applications, which are discussed below, because the protocol needs extra time to verify packets and request retransmissions. If a packet is lost in a CBR audio telephone call, it is more acceptable to allow a skip in the audio, instead of pausing audio for a period of time while TCP requests retransmission of the missing data. When TCP is packaging bytes into packets, it includes a sequence number in the packet header to assist the receiver in reordering data for the application. For every packet the destination receives in order, an acknowledgment packet is sent back to the source indicating successful receipt. If the receiver receives a sequence number out of order, the receiver may conclude the network lost a prior packet and inform the source by sending an acknowledgment (ACK) for the last sequence number received in order. Whether the receiver keeps or discards the latest out of order packet is implementation dependent.

In congestion avoidance mode, TCP increments the window linearly until a congestion event, such as a packet drop, occurs, which triggers scaling down of throughput to reduce network congestion. After backing off, throughput is again ramped up until another congestion event occurs. This, TCP does not settle into a self-pacing mode for long so that TCP throughput tends to oscillate.

The expansionist behavior associated with TCP dynamic window sizing is necessary, since TCP is a best effort service that utilizes congestion events as an implicit means of determining the maximum available bandwidth. However, this behavior tends to have a detrimental effect on QoS parameters, such latency, jitter and throughput. In a scenario where there are multiple competing data flows, TCP cannot guarantee fair-sharing of bandwidth among the competing flows. TCP behavior also affects the QoS of non-TCP traffic sharing the same router queue.

Existing Queuing disciplines do not address these problems effectively. For example, Random Early Detection (RED) does not solve the problem as it only succeeds in reducing throughput peaks and prevents global synchronization. Class Based Queuing (CBQ) can be used to segregate traffic with higher QoS needs from TCP, but this does not change TCP behavior.

Constant Bit Rate (CBR) traffic commonly encompasses voice, video, and multimedia traffic, and in TCP/IP networks. CBR data is commonly sent using the User Datagram Protocol (UDP), which provides a low-overhead, connectionless, unreliable data transport mechanism for applications. In a CBR application, the sending computer encapsulates bytes into fixed-size UDP packets and transmits each packet over the network. At the receiving computer, the UDP packets are not checked for missing data or even for data arriving out of order; all data is merely passed to the application. For example, a telephone application may send a UDP packet every 8 ms with 64 bytes in each in order to obtain the 64 kbps rate commonly used in the public switched telephone network. However, since UDP does not correct for missing data, audio quality degradation may occur in the application unless the underlying network assists and offers QoS guarantees. For CBR traffic, the necessary QoS typically implies guaranteed delivery of all UDP packets without retransmission.

Another known protocol adapted for satellite links is the Satellite Transport Protocol (STP). Unlike TCP, which uses acknowledgments to communicate link statistics, an STP receiver will not send an ACK for every arriving packet. Instead, the receiver sends a status packet (STAT) when it detects missing packets, or when it receives a status request from the sender. This reduces the amount of status traffic from the receiver to the sender. However, throughput advantages of STP over TCP are unclear.

### BRIEF DESCRIPTION OF THE DRAWINGS

The invention will be more fully understood from the following detailed description taken in conjunction with the accompanying drawings, in which:

FIG. 1 is a pictorial representation of an exemplary network having IP-ABR data flows;

FIG. 2 is a pictorial representation showing an exemplary technique for RTT estimation;

FIG. 3 is a schematic representation showing a proxy involved in RTT estimation;

FIG. 4 is a schematic representation showing a proxy involved in RTT estimation for an asymmetric data flow;

FIG. 5 is a schematic representation of a simulation topology for IP-ABR PEP;

FIG. 6 is a graphical depiction of throughput over time for RED plus CBQ;

FIG. 7 is a graphical depiction of throughput over time for IP-ABR;

FIG. 8 is a graphical depiction of utilization versus latency;

FIG. 9 is a graphical depiction of utilization versus latency without silly window compensation;

FIG. 10 is a schematic depiction of an exemplary ABR proxy;

FIG. 10A is a schematic depiction of a router having an ABR proxy;

FIG. 11 is a flow diagram showing an exemplary sequence for packet processing in an IP-ABR PEP;

FIG. 12 is a pictorial representation of an exemplary IP-ABR flow monitor object;

FIG. 13 is a schematic depiction of RTT estimation using flow monitor objects;

FIG. 14 is a pictorial representation of an exemplary flow tracking hash table;

FIG. 15 is a schematic depiction of an exemplary IP-ABR PEP;

FIG. 16 is a schematic depiction of an exemplary test bed topology;

FIG. 17 is a schematic depiction of an exemplary test bed;

FIG. 18 is a graphical representation of normalized link utilization of IP-ABR compared to TCP;

FIG. 19 is a graphical representation of throughput versus time for data flows without an IP-ABR PEP; and

FIG. 20 is a flow diagram to implement IP-VBR.

### DETAILED DESCRIPTION OF THE INVENTION

The below sets forth various acronyms that may be used herein.

| | |
|---|---|
| ABR | Available Bit Rate |
| ACK TCP | Acknowledgment Packet |
| ATM | Asynchronous Transfer Mode |
| BE | Best-Effort |
| BER | Bit Error Rate |
| CBQ | Class Based Queuing |
| CBR | Constant Bit Rate |
| FACK | Forward Acknowledgments |
| IP | Internet Protocol |
| MSS | Maximum Segment Size |
| MTU | Maximum Transmission Unit |
| ns | Network Simulator |
| OS | Operating System |
| OTcl MIT Object Tcl | an object-oriented extension to Tcl/TK |
| PEP | Performance Enhancing Proxy |
| QoS | Quality of Service |
| RED | Random Early Detection |
| RTO | Round-Trip Time Out |
| RTT | Round-Trip Time |
| SACK | Selective Acknowledgments |
| STP | Satellite Transport Protocol |
| VBR | Variable Bit Rate |
| VoIP | Voice over IP |

The present invention provides mechanisms and methods to optimize bandwidth allocation, notify end nodes of congestion without packet losses, and hasten recovery of lost packets for connections with relatively long RTT. In one embodiment, the mechanisms do not require modifications to BE protocol mechanisms.

In one aspect of the invention, an inventive service, IP-ABR service is provided that is well-suited for satellite IP networks. In an exemplary implementation, at least one Performance Enhancing Proxy (PEP) is provided where IP stacks on end systems do not need modification to take advantage of better QoS. In TCP implementations, receivers advertise their maximum receive window to the sender in acknowledgment (ACK) packets.

In an exemplary application of the inventive IP-ABR service, remote subnetworks are interconnected via a geostationary satellite. This network has a relatively large bandwidth delay product and is therefore well-suited to deploy IP-ABR service to improve the QoS. In this network, the IP-ABR service is provided along side IP-CBR and IP-UBR/BE. CBQ can be used to segregate the various traffic classes. In order to allocate bandwidth to the IP-ABR flows, a bandwidth manager (BM) makes use of Performance Enhancing Proxies (PEPs). These IP-ABR PEPs are deployed either at the end hosts, or on an intermediate router. The IP-ABR PEP regulates the corresponding TCP flow, so that the IP-ABR flows will attain the bandwidth allocated to each flow. The BM allocates the assigned bandwidth to routers in this management domain and to the PEPs.

Prior to transmission, an application that wishes to use the IP-ABR service sends a request by specifying its minimum and peak throughput requirement unless bandwidth administration is solely left to the BM. A BM process can process such a request from the client and allocate bandwidth to the end host. The allocated bandwidth depends on the available bandwidth in the network at that moment and the minimum and peak rates requested by the application. The bandwidth is allocated to the PEP, which then regulates the TCP flows in such a manner that they conform to this rate.

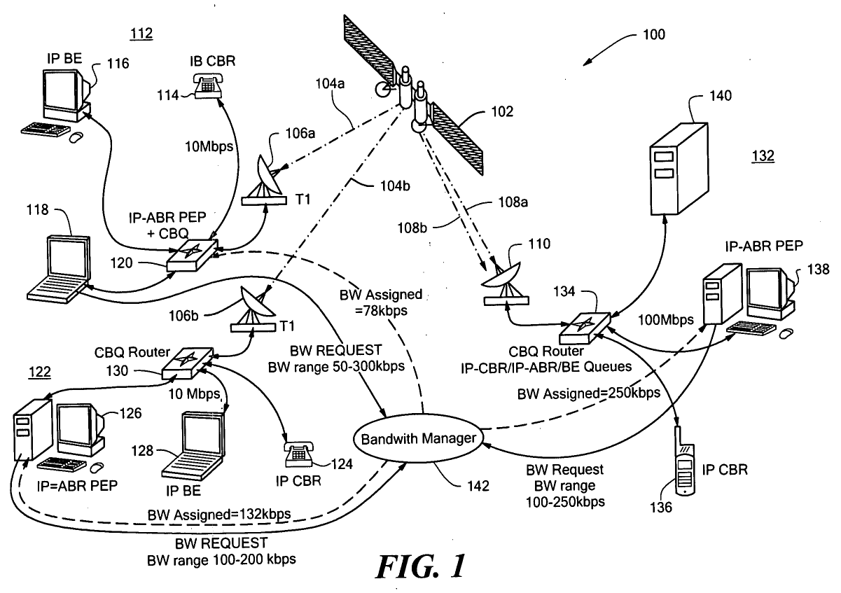

FIG. 1 shows an exemplary network 100 having a various network elements with PEPs to provide IP-ABR service. Data is communicated over a satellite 102 supporting first and second flows 104a,b, shown as T1 links, to respective first and second transceivers 106a,b and third and fourth flows 108a,b to a third transceiver 110.

A first subnetwork 112 includes a telephone 114 having constant bit rate (CBR service, a computer 116 having best effort (BE) service, and a laptop computer 118 having IP-ABR service. Each of these devices 112, 114, 116 is coupled to a first PEP 120, which can form part of a router, which is coupled to the first transceiver 106a and supported by the first flow 104a.

A second subnetwork 122 is supported by the second satellite flow 104b. Devices 124, 126, 128 similar to those of the first network group are coupled to a second PEP 130, which is coupled to the second transceiver 106b.

A third subnetwork 132 communicates with the satellite 102 via the third and fourth flows 108a,b to the third transceiver 110 to which a third PEP 134 is coupled. A mobile phone 136 has CBR service, a computer 138 has IP-ABR service, and a workstation 140 has BE service.

A bandwidth manager 142 communicates with each of the first, second and third PEPs 120, 130, 134 to manage bandwidth allocations as described below. Exemplary bandwidth assignments are shown.

The inventive IP-ABR service enables an end host to specify a minimum rate and a peak rate (or leave it unspecified) for a given flow. Depending on the available bandwidth the network will allocate a “variable” bandwidth between the minimum and peak rates for each flow. One can create an IP-ABR service by dynamically determining the available bandwidth and then redistributing the available bandwidth to end hosts in such a manner that each flow is allocated a bandwidth that will meet the end host minimum requirements. However, since these flows are TCP flows, their throughput is regulated in a manner so that it does not exceed the dynamically allocated throughput.

Band-limiting TCP flows should mitigate congestion and thereby induce the TCP flows into steady self-pacing mode. Such an IP-ABR service can provide the application with reliable transport service, connection oriented service, reduced throughput variation, and enhanced QoS with lower delays and jitter.

In satellite IP networks, such as network 100, link bandwidth varies over time. However, bandwidth requirements of traffic also vary over time. The bandwidth manager (BM) 142 dynamically determines available bandwidth at any given time from the link bandwidth and bandwidth requirements of higher priority traffic. The BM 142 should also be able to redistribute the available bandwidth to the ABR traffic. In one embodiment, the BM 142 can be a service built into the routers. In an alternative embodiment, the BM 142 is instantiated as a separate stand-alone application. The BM 142 keeps track of available bandwidth between end hosts and dynamically allocates bandwidth that meet the host requirements to the extent possible given available bandwidth and priority rules.

The inventive IP-ABR service provides, including for satellite links, advantages to applications, such as better QoS compared to that offered by TCP and guaranteed fair bandwidth usage to individual flows. Advantages are also provided to non-IP-ABR traffic since congestion is reduced, thereby reducing the impact that bursty IP-ABR traffic can have on other traffic types. The IP-ABR service also provides network management advantages by allowing network operators to allocate available bandwidth depending on priority and allowing end hosts to adapt quickly to changes in network bandwidth (useful in satellite networks where bandwidth varies over time.)

In general, the IP-ABR PEPs intercept the in-flight acknowledge (e.g., ACK) frames and limit the advertised window to an optimal size. The optimal window size for a particular flow can be estimated using the path latency between the end hosts and the dynamically allocated bandwidth. By using a PEP to manage ACKs a TCP flow can be regulated without requiring modification of the end stacks. Therefore, the PEP can either be deployed at the end host, or on intermediate routers between the end host, as long as the IP-ABR PEP has access to TCP frames transmitted between end hosts.

The PEPs regulate TCP flows for the IP-ABR service and provide a number of advantages. For example, the use of a PEP does not require modification of existing TCP stack implementations, which allows this mechanism to be backward compatible with legacy TCP stacks. In addition, by locating the PEPs closer to the end hosts, a user can distribute the workload of traffic regulation in the network thereby avoiding extra load on a few routers.

The inventive IP-ABR service provides enhanced quality of service (QoS) by regulating TCP throughput so that congestion is prevented, thereby creating self-paced flows having relatively low throughput variation, low delay and low jitter. In general, the IP-ABR PEP acts as a TCP flow regulator, by which the BM can induce change in TCP transmission rates corresponding to variation of the available bandwidth, thereby creating IP-ABR flows.

The BM, which can also be referred to as a bandwidth management service (BMS), keeps track of the current bandwidth usage and from the available bandwidth dynamically “allocates” bandwidth to IP-ABR service flows. Assume a given network segment or link has a physical bandwidth of BWmax all of which is used by IP-ABR traffic. Also assume that at a certain time t this network segment is shared by n IP-ABR service flows f1, f2, f3, . . . , fn, that have been allocated flow rates of r1, r2, r3 . . . , rn by the BMS, so that each flow is guaranteed at least the minimum bandwidth requested by it and the cumulative bandwidth in use does not exceed the available bandwidth BWavailable. This constraint in allocated rates can be expressed as follows in Equation 1:

$${\sum }_{1 \leq i \leq n} {r}_{i} \leq {BW}_{available} \qquad Eq . 1$$

Similarly, in the case where r1, r2, r3, . . . , rn are expressed as a fraction of Bwavailable, as set forth below in Equation (2):

$${\sum }_{1 \leq i \leq n} {r}_{i} \leq 1 \qquad Eq . 2$$

In the scenario depicted above the available bandwidth is equal to the bandwidth of the physical link, since it was assumed that the network segment only carries IP-ABR service traffic, and therefore the IP-ABR traffic can use all of it. However, in networks with mixed service traffic, the available bandwidth for IP-ABR service traffic varies due to the needs of traffic such as CBR traffic, which may have a higher priority than IP-ABR traffic. Therefore, an increase in bandwidth needs of higher priority traffic, leads to a reduction in available bandwidth. Assuming at time t that the bandwidth needs of higher priority traffic is BWhp, then the available bandwidth can be estimated by Equation (3) below:
BW_{available}=BWₘₐₓ−BW_{hP} Eq. 3

As the available bandwidth changes on a given network segment, the BMS must re-estimate the allocated bandwidth for each flow and with the aid of an IP-ABR PEP adjust the TCP transmission rate correspondingly. However, in a packet network a “channel” between two end hosts is a virtual path through the physical network. The channel path may pass through more than one network segment, where each segment along the channel path has a different available bandwidth at any given time. Therefore, in the case of IP-ABR service, the bandwidth allocated to an IP-ABR service flow by the BMS, should not be greater than the available bandwidth on the segment with the least available bandwidth.

In the case of protocols such as TCP, which use a sliding window mechanism for flow control, the window size used for the sliding window will limit the achieved bandwidth. In a sliding window protocol, if one assumes there are no errors, then a source may keep transmitting data until it reaches the end of the transmit window. If the transmit window size is limited to a particular size WL, then the bandwidth achieved can be estimated by Equation (4) below:

$$β = \frac{{W}_{L}}{2 a + 1} \qquad Eq . 4$$

where a is the propagation delay between end hosts. Using this relationship for a sliding window mechanism one can compute in accordance with Equation (5) below the optimal window size WL for a given bandwidth β, where β is less than the bandwidth of the physical link:
W_{L}=└β×(2α+1┘ Eq. 5
In Equation (5) above the term 2a+1 can be approximated by the round trip time (RTT) of a segment, with the assumption that there are no queuing delays or retransmission delays due to packet loss. One can define the round trip time as the time interval between a packet transmission and arrival of an acknowledgement from the receiver.

For an IP-ABR service TCP flow, the optimal window size Wndopt required to achieve the allocated throughput of BWallocated is given by Equation (6) below:

$${Wnd}_{opt} = ⌊ {BW}_{alloc} \times \frac{{data}_{size}}{MTU} \times RTT ⌋ \qquad Eq . 6$$

In Equation (6) the value of Wndopt may be rounded down to the nearest octet, since TCP windows are expressed in terms of octets. Equation (6) should be valid as long as the throughput allocated by the BMS BWallocated is greater than MSS RTT. Since, when BWallocated is equal to MSS RTT only a single segment is in transit between the end hosts, any further reduction in throughput will require segments of fractional MSS size, which cannot be transmitted, because of a so-called silly-window avoidance mechanism included in most TCP stacks, which prevents the stack from transmitting segments of a fractional MSS size.

In order to compute the optimal window size for a particular flow, the IP-ABR PEP should accurately estimate the round trip time (RTT). In order to reduce overhead, TCP transmits data in blocks each of which is referred to as a segment. The smallest block size that can be transmitted is referred to as the minimum segment size (MSS). In most operating systems the MSS is a user configurable setting and on most systems is set to the default value of 536 bytes. Assuming there are no packets lost, the RTT for a TCP segment is the time it takes from when a segment is transmitted to when an acknowledgement is received for it. In other words when a TCP segment is transmitted with a sequence number X at time t1, an acknowledgement will be sent back with an ACK number equal to X+MSS+1. The acknowledgement number informs the sender of the starting octet of the data that the receiver is next expecting. If the corresponding ACK is received at t2, than the RTT=t2−t1.

In order to estimate the RTT for each flow the PEP keeps track of arrival times of segments that have not been acknowledged yet. This technique assumes that every data segment transmitted will have a corresponding ACK which is not always true. TCP acknowledgements can sometimes be grouped together in a single ACK.

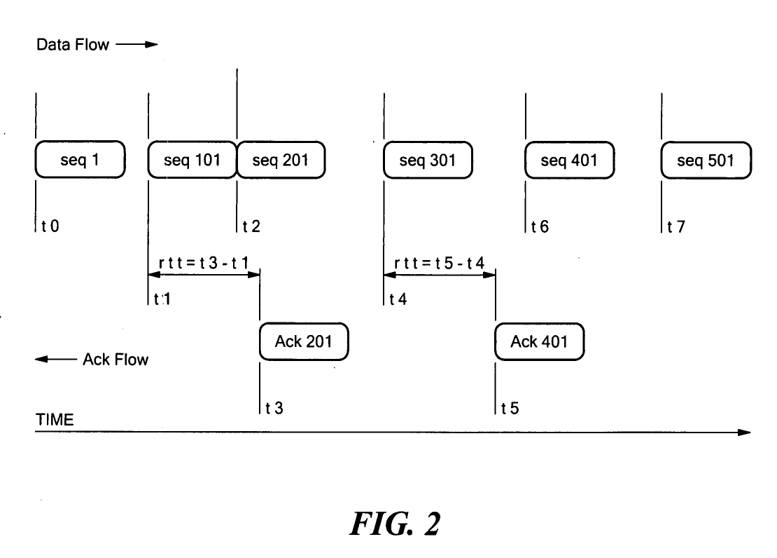

For example, as shown in FIG. 2, sequence numbers 1, 101 . . . 501 are sent by the sender. Here, the destination ACKs back both packets simultaneously, by only returning a single ACK ACK201 at time t3 for the latest segment it received (which is shown as 101). One accounts for this scenario by modifying the RTT estimation technique originally described, by estimating the RTT as the time difference between the time of transmission of the “latest” segment whose sequence number is less than an acknowledgement number and the arrival time of that acknowledgement, here shown as rtt=t3−t1.

As noted above, RTT was approximated as twice the propagation delay, where the propagation delay is equal to the link/channel latency. However, the RTT is greater than the propagation delay, since in addition to propagation delay the RTT also includes the queuing delays and retransmission delay experienced by a transmitted segment and its corresponding ACK. When a packet gets lost during transmission in a channel, the TCP ARQ mechanism retransmits the packet. However, there is no guarantee of successful transmission even when a segment is retransmitted, therefore multiple retransmissions might be required, thereby resulting in more than one segment with the same sequence number passing by the IP-ABR PEP. When an acknowledgement for one of the many retransmitted segments is received, it is not possible to match it to a particular retransmission, since one cannot determine which of the transmitted duplicates have been dropped/lost and which have been not. Thus, one may not be able to correctly estimate the RTT for retransmitted segments. Hence, one avoids estimating RTT for segments that get retransmitted. So if the IP-ABR PEP encounters a segment that is a duplicate of one it has already seen it raises a flag, so that RTT will not be estimated when an ACK corresponding to the retransmitted segment arrives.

RTT estimation using the scheme described above includes both the channel latencies and queuing delays. However, the focus here is estimating just the channel latency. Hence, a scheme is described that can separate the queuing delays from the estimated RTT. If one does not separate queuing delays from the RTT estimate it may be detrimental to IP-ABR operations. This is due to the fact that using RTT estimates that include queuing delay results in an inflated bandwidth delay product, thereby, giving the IP-ABR PEP an impression of a channel with longer latency than the actual latency. This in turn causes the end hosts to inject more segments into the channel, which in turn creates further congestion and leads to larger queuing delays. This increase in queuing delay can again factor into the IP-ABR PEPs window estimation, thereby, creating a feedback loop which will eventually lead to congestion and packet loss, as result of which the IP-ABR service flow breaks out of self-pacing mode. To prevent this, a scheme was developed in which there is “skim off” the queuing delay based upon the fact that for a given flow the link/channel delays are mostly constant, assuming that the route between end hosts does not change. Queuing delays on the other hand tend to fluctuate, causing variation in estimated RTT values. Thus, one can attribute any increase in estimated RTT to an increase in queuing delay, and similarly any decrease in RTT estimation is attributed to a decrease in queuing delay. Therefore, in order to estimate the link latency one looks for the smallest RTT estimate; the smaller the RTT estimation the closer it is to the link latency. As can be seen, the link latency should not vary with time. Route variation is a phenomenon in connection-less packet-switched networks where packets belonging to the same flow (i.e., packets with the same source and destination), may take different routes before they arrive at the destination. One should accommodate slow variation in route delay such as induced by movement of satellite relay stations. Thus, in an exemplary embodiment, the estimation function involves weighted averaging with a lesser but non-zero weight given to RTT values greater than the current RTT estimate.

To estimate the smallest RTT one can compute a weighted average RTT as set forth below in Equation (7):
arrtₙ=wt×rttₑₛₜ+(1−wt)arrtₙ₋₁ Eq. 7
where arttn is the average RTT after the nth sample, rttest is the estimated RTT of the nth sample, arttn-1 is the average RTT of the n-1 sample and wt is the weightage given to the nth RTT sample. Different weights can be used depending on whether the sample RTT is greater than the average RTT or not, since arttn should be closer to the smallest RTT. Therefore, larger weight is given when rttest is less than arrtn-1 and a smaller weight is used when rttest is greater than arttn-1.

From simulation experiments it was found that the ranges for suitable weights can be defined as set forth below in Equation (8):

$$wt = \{ \begin{matrix}0 < x \leq 0.002 & if {rtt}_{est} \geq {artt}_{n - 1} , \\ 0.6 \leq x < 1 & if {rtt}_{est} < {arrt}_{n - 1} .\end{matrix} \qquad Eq . 8$$

The mechanism described above assumes that the PEP is located at the sender.

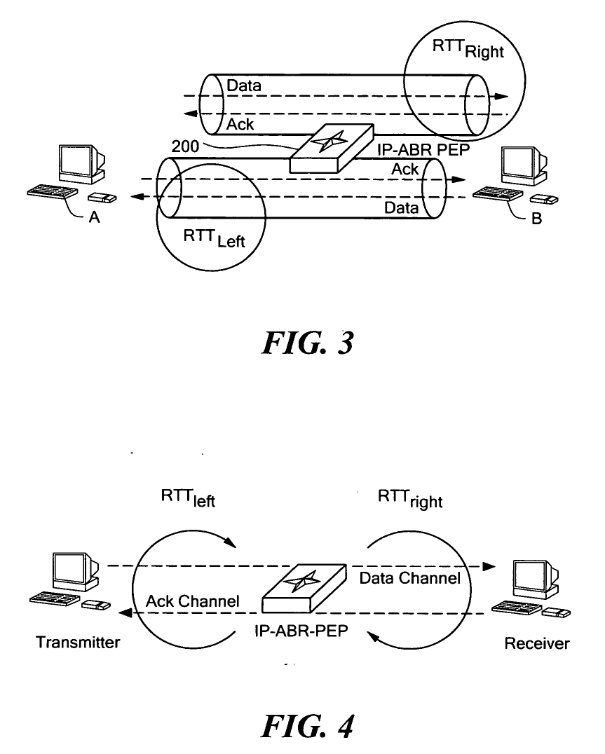

When a PEP 200 is located midstream as depicted in FIG. 3, the RTT estimation can be done on both sides of the router. Referring to these RTT estimates as RTTleft and RTTright, RTTleft is estimated using data flowing from device B to device A and ACKs flowing from A-B. Similarly, RTTright can be estimated using the flows in the opposite direction. As a result of this split RTT estimation, the total RTT for a flow is the sum of RTT estimates on both sides of the PEP as described in Equation (9) below:
RTT=RTT_{Left}+RITT_{right} Eq. 9

One can make use of this scheme, even if the PEP is located at the end host. Since, if the PEP is located at the transmitter RTTleft is essentially zero then RTT=RTTright. However, there is a limitation here. As can be seen, to estimate both RTTleft and RTTright data is flowing in both directions.

If the connection is asymmetric as shown in FIG. 4, where data only flows in one direction, one cannot correctly estimate RTT without some data flows in the other direction. However, by placing the PEP as close as possible to the sender one can avoid this problem. Another advantage of distributing the IP-ABR PEPs closer to the edge is that the processing load is more disbursed. Hence, a good general strategy may be to place IP-ABR proxies at each host even though in a general sense this is not a fundamental requirement for implementing the inventive IP-ABR service. Throughout this specification and exemplary code segments, the latter strategy is assumed to take the full link latency to be reflected by the proxies ongoing traffic RTT estimate.

An exemplary implementation of the inventive IP-ABR Proxy was simulated to validate the algorithm and mechanisms. A Network Simulator (NS), which was used for the simulation, is an event driven simulation tool developed by the Lawrence Berkeley Labs (LBL) and the University of California at Berkeley to simulate and model network protocols. NS has an object oriented design, and is built with C++, but also has an ObjectTCL API as a front end. As described above, the goal of the IP-ABR PEP is to regulate TCP flows to attain a predetermined bandwidth such that TCP flows are held in a self-paced mode for the duration of test, thereby, achieving throughput with minimal variation for the duration of the flow.

A first test involved capturing throughput variability statistics over time. In addition to looking a throughput variability, it was also verified that bandwidth distribution across several flows is fair for which a second set of tests were conducted.

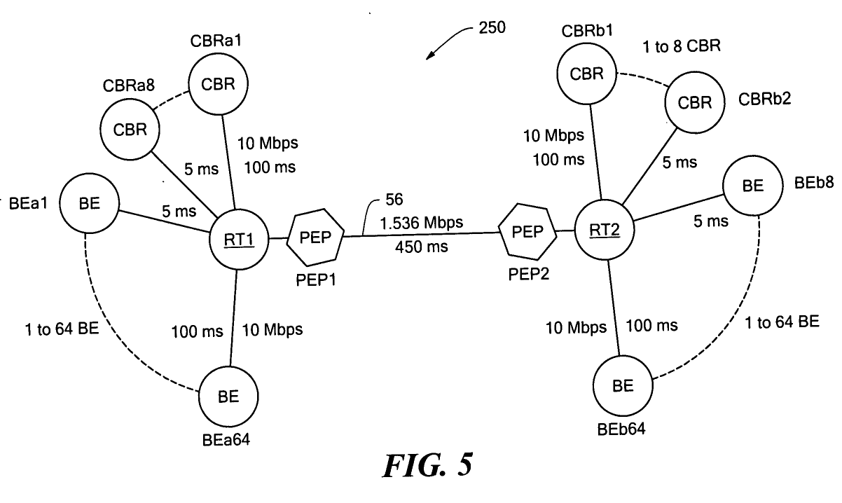

As depicted in FIG. 5, a simulation topology 250 includes 64 best-effort BEa1-64, Beb1-64 and 8 constant bit rate CBRa1-8, CBRb1-8 entities placed on either end of a satellite link. First and second routers RT1, RT2 were used to connect the 72 hosts on each side to the satellite link SL. The link is similar to a bi-directional T1 satellite link in which the link has a latency of 450 ms and a 1.536 Mbps bandwidth in each direction. Each host was connected to the router over a high speed link (10 Mbps). The link latencies of the high speed links range between 5 and 100 ms. The link latencies on the end links were varied to simulate a scenario where each TCP flow has a different round trip time (ranging from 910 to 1100 ms). In addition, an IP-ABR PEP PEP1, PEP2, was attached to each of the routers. The proxy node has access to the associated router queue so that it can allocate bandwidth to each flow by modifying the ACK frames in transit. The hosts were configured such that, for each host at one end of the link, there was a corresponding host at the other side of the link, forming a pair.

During the tests, a host from each end host pair would send a constant stream of data to the paired host over the bottleneck satellite link SL over a TCP connection. This results in bi-directional TCP traffic flows between hosts, referred to as forward and reverse flows. The “full stack” New Reno implementations of TCP were used to simulate the TCP traffic. The constant bit rate traffic simulated was intended to be similar to voice traffic, so, the CBR hosts were configured to transmit 64 bytes of data, that is a corresponding 92 byte IP packet, every 8 ms using UDP. Correspondingly, each CBR pair had a bandwidth requirement of 92 kbps. Voice traffic requires minimal jitter and packet loss, since UDP is an unreliable protocol and any packet loss will lead to degradation in voice quality. Thus, if TCP traffic shares a queue with CBR traffic it will cut into the bandwidth needed for the CBR traffic, thereby degrading CBR traffic QoS. Therefore, in order to meet the QoS needs of the voice traffic one must guarantee the required bandwidth and segregate it from TCP traffic. To do so, class based queuing (CBQ) was used at the router. In the simulation, CBQ was configured to segregate the two different traffic classes (CBR and BE) into separate queues. The CBR queue was managed with a drop-tail queuing discipline. The queuing discipline for the BE traffic was either drop-tail or Random Early Detection (RED) depending on the test. The CBR traffic was given a higher priority than the TCP traffic. The queue size for the TCP traffic was 64 packets long. The queue size for the CBR flows was computed as in Equation (10) below:

$${qsize}_{cbr} = A + {cbr}_{num} \cdot \frac{8 \cdot {cbr}_{size} A}{β \cdot {cbr}_{interval}} \qquad Eq . 10$$

where in this example cbrnum=8, cbrsize=64, cbrinterval=8 ms and A is the number of CBR packets that arrive in the time it takes to transmit a BE packet, which can be estimated as follows in Equation (11):

$$A = {cbr}_{num} \cdot ⌈ \frac{8 \cdot {be}_{size}}{β \cdot {cbr}_{interval}} ⌉ \qquad Eq . 11$$

This CBQ configuration guarantees that the bandwidth needs of CBR traffic are met, and it also isolates it from the TCP traffic, thereby offering better QoS. As mentioned previously, using CBQ in the network is a typical technique used to meet the various QoS requirements of different traffic classes.

In the tests, TCP traffic was stagger-started in such a manner that 8 flows were started at a time every 0.5 secs, and for, the first 120 seconds TCP end hosts were given the entire bandwidth of the satellite link. This provided sufficient time for all flows to go through the initial slow start phase. The 8 CBR pairs started transmitting at 120 secs from the start of the test. The bandwidth needs of the CBR traffic were guaranteed by using CBQ. This results in a reduction of the available bandwidth for the TCP traffic. TCP hosts adjust to this reduction in available bandwidth in order to prevent congestion. What was sought in this test, was to see how TCP throughput varies over the duration of the test. Of interest was seeing how TCP throughput behaves in situations wherein available bandwidth is constant and also when it varies in response to needs of higher priority traffic. However, unlike CBR traffic, TCP traffic is bursty by nature. If one were to look at the instantaneous throughput rate one would always see large variations. However, instead of looking at the instantaneous throughput, if one were to look at throughput over an appropriate interval less variation would be seen.

Therefore, a technique of window averaging was used averaging the throughput sampled over a 5 second window interval, every time a block of data is received at the receiver application. This moving window approach dampens the variations attributed to TCP's bursty nature, but still allows observation of variations in throughput caused by the dynamic window sizing described previously.

Two types of tests were conducted. In the first test type, Random Early Detection (RED) was enabled on the TCP traffic queue with the minimum and maximum thresholds set to 32 and 64 respectively. In the second test a drop-tail queuing disciple was used with the maximum queue size set to 64 packets, with the IP-ABR PEP enabled and attached to each router. Each of the IP-ABR PEPs regulates the TCP sender on its side of the link. In this simulation the IP-ABR PEP is configured to distribute the available bandwidth equally amongst the competing TCP flows.

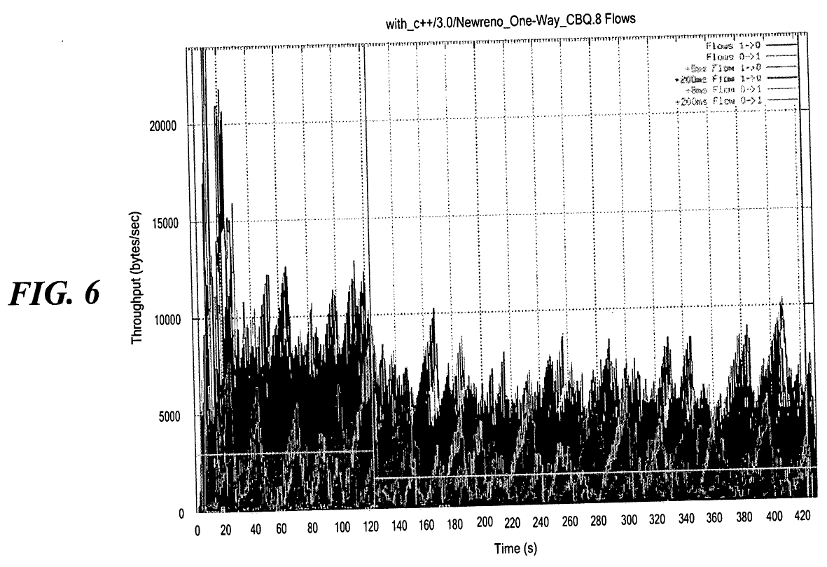

FIG. 6 shows a plot of TCP throughput measured for each flow for RED as the queuing discipline for the TCP queue. The New Reno version of the TCP stack was used in this simulation. As can be seen, despite available bandwidth being constant for the periods between 0-120 secs and 120-240 secs, the throughput of each individual flow varies. TCP throughput seems to repeatedly climb and drop exhibiting an irregular oscillatory behavior. The reduction in the steepness of the peaks in the later half (i.e., after 120 secs) has to do with reduction in available bandwidth to TCP flows from 1.536 Mbps to 0.736 Mbps due to the 8 CBR sources coming online as described above. The irregular oscillations that the throughput exhibits is expected, since after an initial ramp up during slow start TCP does not maintain a steady-state, instead TCP stacks constantly search for an upper bound by linearly incrementing their windows, which in turn causes the throughput to grow and will eventually create congestion at the queue at the bottleneck link, which in turn triggers congestion alleviation, causing the drops. This pattern is irregular, since there are multiple TCP flows sharing a link, each competing against the others with congestion reaction times that are dependent on the traffic rates and propagation delays. This results in some flows more often getting a higher throughput than others, which leads to unfair average distribution of bandwidth.

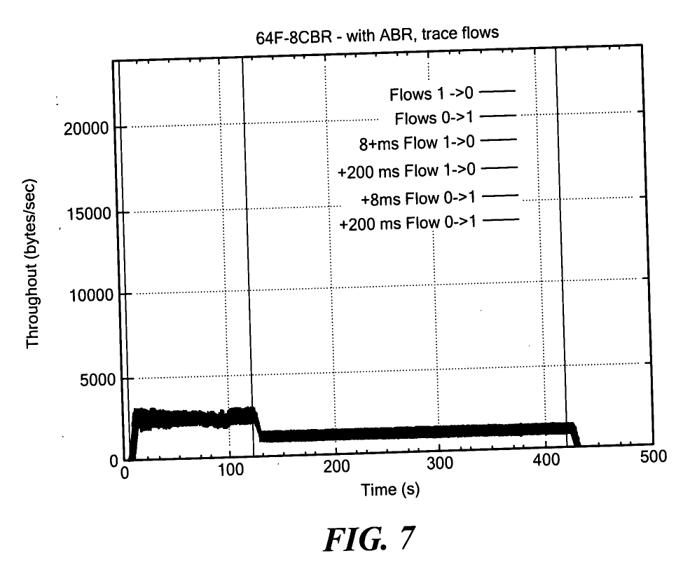

FIG. 7 shows the results of the test using IP-ABR PEP, which paints a contrasting picture to the previous test. As can be seen, the TCP throughput does not vary throughout the test except for the moment at which the available bandwidth changes. As soon as the IP-ABR PEP (See FIG. 5) can estimate the RTT for a TCP flow, the flow is band-limited by the PEP, so that the end hosts do not inject more than the optimal number of segments required to meet the allocated bandwidth. Just as in the previous case, the TCP flows go through a slow start period where the window is exponentially ramped up, however, before any congestion occurs it will hit the window limit set by the IP-ABR PEP since the window is clipped to the optimal size. At this point, TCP will enter into self-pacing mode for the duration of the test, thereby achieving a throughput with minimal variation. The window size varies when the IP-ABR PEP modifies the window limit corresponding to changes in the allocated bandwidth. In the case of this test, the bandwidth of the IP-ABR service flows is reduced at 120 seconds to meet the needs of the higher priority CBR traffic.

Another test was conducted to verify that the IP-ABR PEP can guarantee fair bandwidth usage. In conducting this test a similar configuration was used to that of the previously described throughput variability tests. However, the 8 constant bit rate (CBR) hosts from each end were removed. Another change is keeping the available bandwidth constant for the duration of the test. This allows the TCP traffic to use all of the satellite link bandwidth. The IP-ABR PEP was configured to equally distribute the available bandwidth to each connection. The test duration was shortened to a period of 100 secs. The test was repeated for the various TCP MSS settings of 256, 536, 1024 and 1452 bytes.

Fairness is a vague concept, since it is subjective with respect to the needs of the end host. So what may be fair to one application may not be fair to another. This makes it difficult to define a single measure to quantify fairness. However, of interest here is the scenario where an IP-ABR PEP is trying to regulate flows, such that the link bandwidth is equally shared amongst the various BE flows. The closeness of the achieved throughput (or goodput to be precise, since the focus is on packet traffic that successfully enters the receiver delivered data stream) to the desired rate should be reflected by the measure of fairness. In other words, if there are N hosts sharing a link with a bandwidth β, the throughput utilization of each of the flows should be β/N. One can measure per-flow link utilization achieved for each flow in Equation (12) below:

$${Util}_{link} = \frac{N \cdot {\sum }_{1 \leq i \leq k} MSS}{β \cdot T} \qquad Eq . 12$$

where β=1.536 Mbps (satellite bandwidth), N=64 (number of BE flows) and k is the number of segments successfully delivered to an application by the receiver over the duration of the test (T secs).

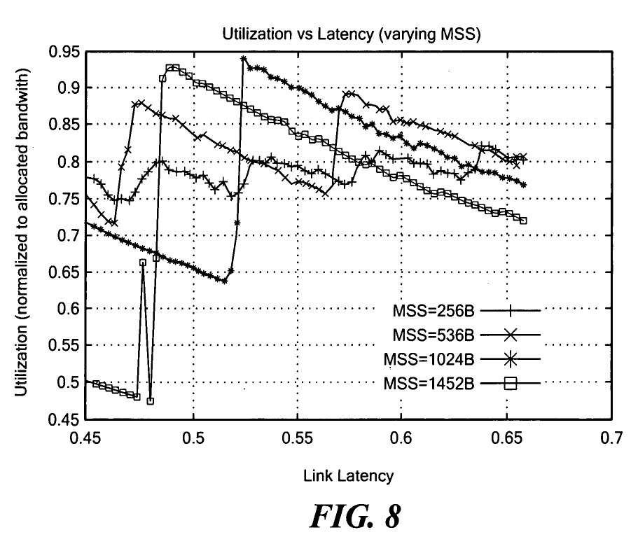

After measuring the utilization of the various flows it was concluded that the flow utilization values were spread over a range between 0.72 to 0.95 of the normalized bandwidth allocated by the IP-ABR PEP (which in this case is equal for all the flows). To determine if there is a pattern to this distribution, the variables that are involved in computing the window size were examined. Of all the variables, only the RTT varies significantly between the flows, since the test network topology was configured so that the link latencies between end hosts vary between 910 and 1100 ms. The utilization was plotted against the respective channel/link latency in FIG. 8 showing that the utilization appears to be distributed in a pattern with respect to the link latency. This pattern was noticed in all tests irrespective of the MSS, but as can be seen there also seems to be some relationship to the MSS. This relationship between utilization, RTT and MSS provides less than optimal air usage of bandwidth. The bandwidth delay algorithm used in the IP-ABR PEP to compute the optimal window size was examined. As stated above, the optimal TCP window size can be computed and rounded down to the nearest octet. However, from examination of TCP stack implementations it was discovered that, when a TCP sender receives a window size advertised by the receiver, it will round down the window to the nearest MSS. This is to avoid phenomena called “silly window syndrome,” to which sliding window based flow control schemes are vulnerable, wherein the sender sends several packets smaller than the MSS size, instead of waiting to send a single larger MSS size packet.

In order to enable IP-ABR PEP to guarantee fair bandwidth usage, the algorithm used to estimate the optimal window size should compensate for window rounding. In an exemplary embodiment, the IP-ABR PEP estimates the optimal window size for a particular flow as described above and then rounds down the optimal window size to the nearest MSS to get the actual window size wndactual. Rounding down the optimal window size creates a deficit in the allocated bandwidth. To make up for this deficit, the deficit is estimated and carried forward as credit and applied to subsequent window computations. This is done by computing the difference δcredit between optimal window size and actual window size, and then carrying the credit forward. Upon receiving the next subsequent ACK packet for the flow, one applies it to the optimal window size before rounding again. The new modified algorithm and be expressed as follows in Equation (13)

$$wnd = {δ}_{credit} + ( {β}_{available} \times \frac{{data}_{size} \times RTT}{MTU} \\ {δ}_{credit} = wnd mod MSS \\ {wnd}_{actual} = wnd - {δ}_{credit} \qquad Eq . 13$$

Prior to this modification, the value of the optimal window size was fairly constant (unless there was a change in the available bandwidth or the RTT). With this modification, window sizes set by the IP-ABR may periodically fluctuate between W and W+MSS, where W is the actual window size or the optimal window size rounded down to the nearest MSS. However, this small variation in burst sizes will not lead to a noticeable variation in throughput.

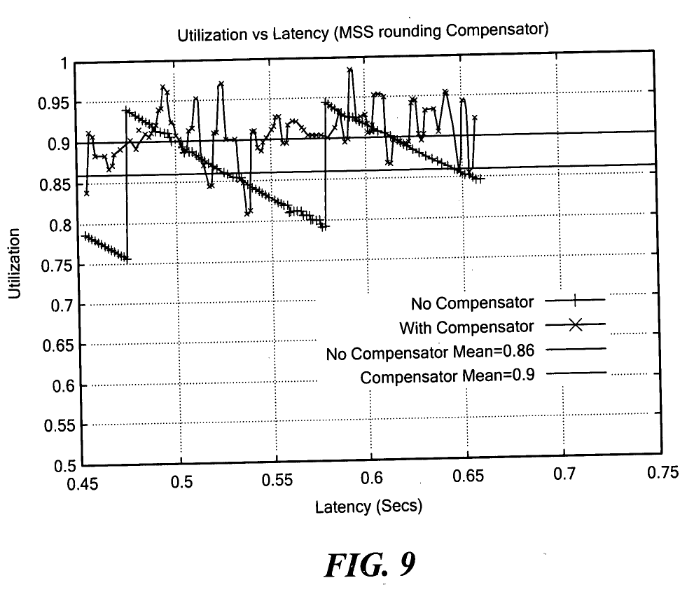

After making the modification to the optimal window size estimation algorithm, the previous test was repeated. Unlike the earlier fairness test conducted for a range of MSS values, in this test a single test was run with the MSS set to 512 bytes. FIG. 9 shows the results of that test in comparison with the results prior to the modification. The modification succeeds in breaking a relationship between utilization and latency. The overall utilization (the combined utilization) improves from 86% of link capacity to 90%.

As described above, the inventive IP-ABR PEP dynamically allocates bandwidth by means of dynamic window limiting of TCP flows, which can be achieved by modification of in flight ACK packets. In conjunction with a bandwidth management service allocating bandwidth, IP-ABR PEPs induce flows that have lower delay, lower jitter and less packet loss than compared to regular TCP flows. It also allows the bandwidth management service to dynamically adjust flows to use available bandwidth as services change over time.

In an exemplary embodiment, the IP-ABR proxy has an object-oriented design developed using the C++ programming language. This allowed reuse of code from the simulated version without major modifications, since most of the algorithms and techniques used in the simulated version were developed using C++ standard template libraries. The prototype IP-ABR proxy was designed to run as daemon process.

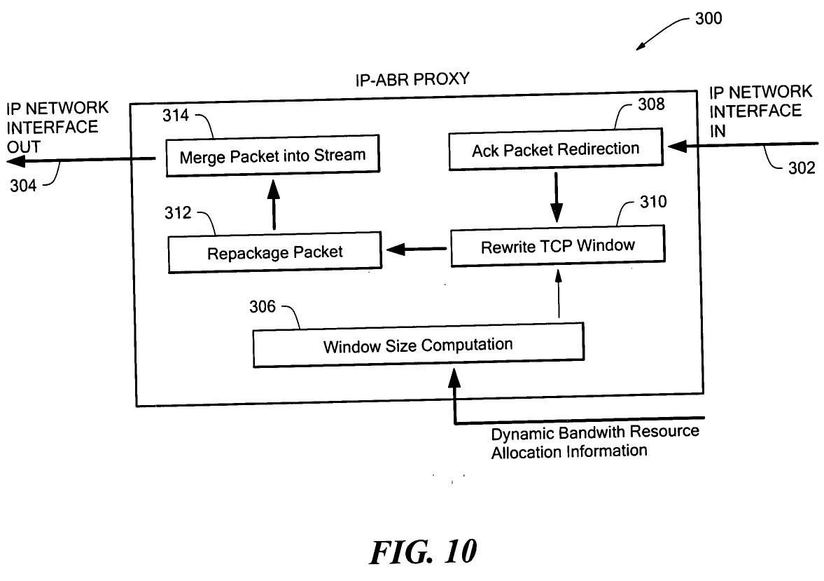

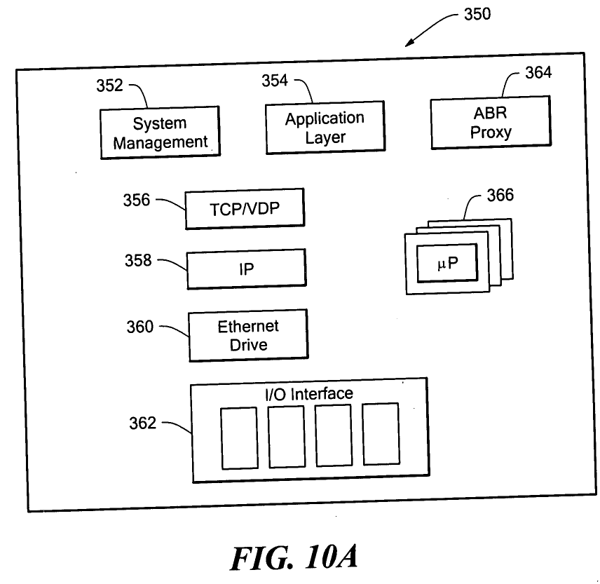

FIG. 10 shows an exemplary block diagram for an ABR proxy 300 in accordance with the present invention. The proxy 300 includes an IP input network interface 302 and an IP output network interface 304. A window size computation module 306 computes window sizes based upon dynamic bandwidth resource allocation information from a BMS. A first module 308 performs ACK redirection for a packet as described above and a second module 310 rewrites the TCP window size. The packet is repackaged in a third module 312 and merged into a data stream in a fourth module 314. The stream exits the proxy via the IP output network interface.

As noted above, the proxy 300 can be provided as a standalone device or can be incorporated into a router. FIG. 10A shows an exemplary router 350 having system management 352 to manage the device and an application layer 354. The router 350 includes a TCP/UDP layer 356 and an IP layer 358 interfacing with an Ethernet driver 360 exchanging data with a network I/O interface 362. The router 350 further includes an ABR proxy 364, such as the proxy 300 of FIG. 10. The router 350 includes a series of microprocessors on circuit cards 364 to implement router functionality.

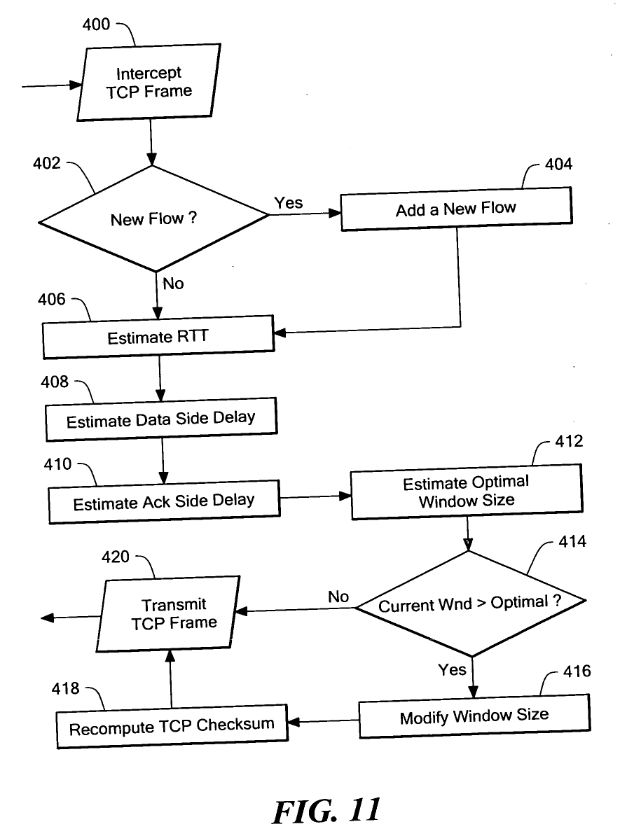

FIG. 11 is a flow diagram showing an exemplary sequence of steps to process a TCP packet by the IP-ABR PEP. In step 400, a TCP frame is intercepted and in step 402, it is determined whether the frame is for a new data flow. If so, in step 404 the new data flow is added to previously recognized data flows. In step 406, the RTT is estimated for the data flow and in step 408 the data side delay is estimated. In step 410, the ACK side delay is estimated and in step 412 the optimal window size is estimated by the BMS for the allocated bandwidth and channel latency. While the bandwidth allocation is determined by the BMS, the IP-ABR PEP monitors the flows and determines the channel latency.

In step 414, it is determined whether the current window size is greater than the computed optimal window size. If so, in step 416 the window size is modified and in step 418 the TCP checksum is re-computed. Then in step 420, which is also the “no” path from step 414, the TCP frame is transmitted.

In order to estimate the RTT for each flow, the PEP keeps track of data packets that have not been acknowledged previously. Then, using the RTT the link latency is estimated as described above, by estimating the weighted average RTT (ARTT) for the first n-1 samples per flow, where higher weighting is given to smaller RTT estimates, thereby giving an ARTT that approaches the natural link latency. Another variable that is also tracked on a per flow basis is the credit δcredit defined above, which is the difference between optimal window size and actual window size. Any reminder can be applied to the subsequent packet.

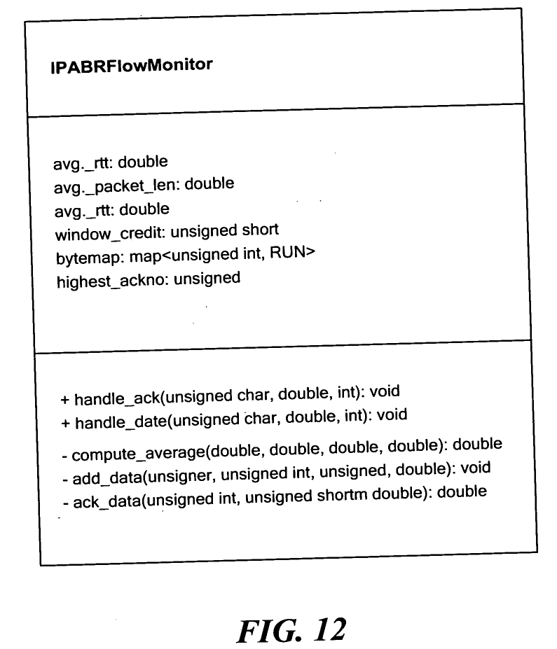

To handle operations on a per flow basis, an exemplary flow monitor object illustrated in FIG. 12 is used. For each flow being regulated by the IP-ABR PEP, an IP-ABRFlowMonitor object is instantiated. Each flow monitor object instantiated keeps track of the average RTT (avg rtt), the average packet size (avg pkt) and the window credit (window credit). In addition to these attributes, each flow monitor object also maintains a list of unacknowledged data packets with their corresponding arrival time stamps. As previously above, the arrival time is used to estimate the RTT and subsequently the ARTT when an ACK is received.

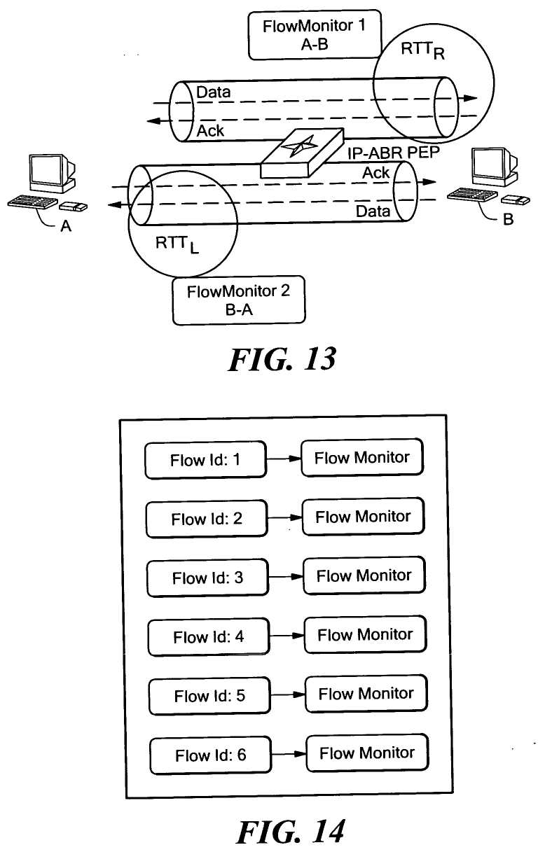

As shown in FIG. 13, when an IP-ABR PEP receives a new TCP frame that is bound from source A to destination B, the IP-ABR PEP first retrieves the flow monitor object for the left flow (i.e., B-A) and the right flow (i.e., A-B). Let us refer to them as FlowMonitors 1 and 2. FlowMonitor 1 can estimate the RTT on the “right” side to the PEP by using data flowing from A to B and ACKs from B to A. Similarly FlowMonitor 2 can estimate the RTT on the left side using the flow in the opposite direction. When a packet from host A arrives, it contains data flowing from A to B and may also contain an ACK from B to A. In order to process the packet, the PEP first calls the handle data function within the flow monitor 1 object. If this frame contains a new sequence number, the flow monitor will make a new time-stamped entry to keep track of the packet's arrival. This function then returns the last RTT measured on the right side of the PEP (RTTR). After calling the handle data, the IP-ABR proxy calls the handle ack function within the flow monitor 2 object (i.e., B-A). The handle ack function is passed to the packet and the RTT measured on the right side of the proxy. The handle ack function retrieves the acknowledgement number within the packet and using the acknowledgement number estimates the RTT on the downstream side. As described above, this is done by finding the time interval between the acknowledgement arrival and the arrival of the latest data packet corresponding to the acknowledgement. Now, the IP-ABR PEP estimates link latency between the end hosts by adding both left and right sides. In other words RTT=RTTL+RTTR.

Using the RTT estimate, the handle ack function computes the optimal window as described previously. If the optimal window size is less than the current window size within the packet, it is replaced with the optimal window limit. As noted above, in order to process a frame the IP-ABR PEP needs two flow monitor objects. Whenever a new flow is encountered for which there are no flow monitor objects, the proxy instantiates two new FlowMonitor objects. FlowMonitors objects are destroyed when a flow terminates, which occurs when the PEP detects a FIN packet, signaling connection termination.

The IP-ABR PEP will typically manage multiple flows simultaneously. Since each flow may require two FlowMonitor objects the proxy will have to keep track of them all. To facilitate flow tracking, in an exemplary embodiment the IP-ABR PEP uses a hash table of FlowMonitor objects as illustrated in FIG. 14. A C++ standard template library “Map” class was used to implement this flow tracking table, in one particular embodiment. Flows can be uniquely identified by their source address, source port, destination address and destination port, which are used to construct a flow identity, which in turn is used as key in the hash table. Therefore, each flow-ID has a one-to-one relationship with a FlowMonitor object.

As noted above, the IP-ABR PEP can be deployed on either an end host or on an intermediate router. In both scenarios, the IP-ABR PEP should be capable of “transparently” intercepting the TCP frames. In most operating systems, access to packets is normally restricted to the kernel. However, a number of illustrative techniques are available to work around these restrictions.

One technique is to design the IP-ABR PEP as a kernel module, since there are very few restrictions placed on kernel modules because they operate in the kernel memory space. One consideration in taking this approach is that any instability in the module may result in crashing the system. It may also be relatively more complicated to develop the IP-ABR as a kernel module, since the C++ libraries used previously may not be able to be used in the kernel. Another factor in this approach is that porting to another platform would require extensive changes to most of the program.

Another technique is to use so-called Raw Sockets. Raw sockets are a feature first introduced in the BSD socket library. However, Raw socket implementations vary between platforms. On some platforms, access to TCP frames is not allowed. However, both Linux and Windows operating systems support access to TCP frames via this interface, which would make the code portable. However, in order to use raw sockets, source routing must be supported on the platform, which is not supported by the Windows operating system.

Another technique utilizes a firewall API. Firewall programs require access to packets passing through the kernel. On most operation systems firewall programs are implemented as kernel modules. In the past, most of these systems were mostly closed to modification by end users. However, because of the increasing complexity of rules governing firewall operation firewall programs are being made extensible. Some of these implementations provide interfaces through which user space applications can access packets. The Linux operating system provides such a mechanism in its Netfilters firewall subsystem. One advantage of using this scheme is that it allows a large portion of the code to be platform independent, with only the small portion of coding that interfaces with the firewall API requiring porting.

As is well known, the firewall architecture used in Linux has dramatically changed over the years. Prior to version 2.4 of the kernel, Linux used the “ipchains” program to implement firewalls. This is similar to the implementation of ipchains on the various BSD platforms of FreeBSD, Open BSD etc. A common problem with the ipchains architecture was that it did not have a proper API that could facilitate easy modification and extension.

The Firewall subsystem was redesigned during the development period prior to kernel version 2.4. As a result of this development, a new Firewall subsystem called netfilters was developed. The old ipchains program was replaced with a new program called “iptables”. The new netfilters architecture also provided a new API to extend the existing functionality. One of the early extensions developed is a program called IPQueue, which is a kernel module that has been included in the kernel source since version 2.4.

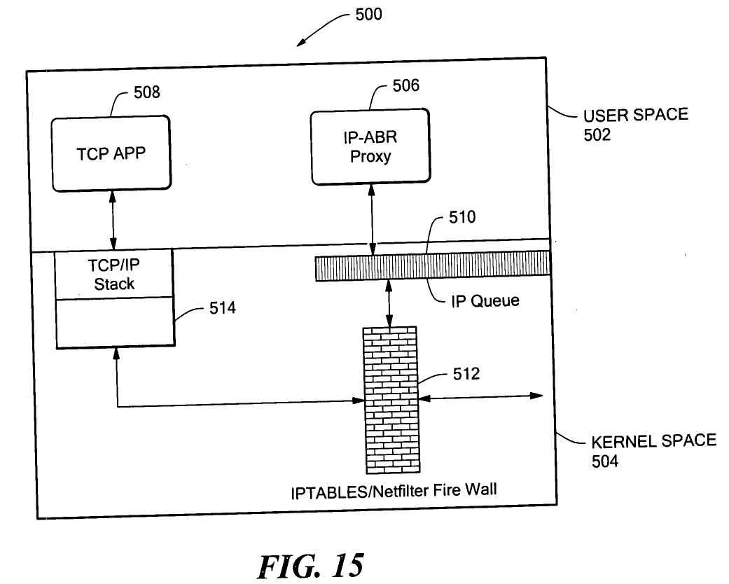

As illustrated in FIG. 15, in an exemplary embodiment 500 includes a user space 502 and a kernel space 504. The user space includes an IP-ABR PEP 506 and a TCP application 508. The kernel space 504 includes an IP queue module 510, firewall 512 and TCP/IP stack 514. The IP Queue module 510 interacts with the IP-ABR PEP 506 and the firewall 512. The IP-Queue module 510 allows a user to configure firewall rules that instruct the kernel to forward packets to a user space application. In an exemplary embodiment, the IP-ABR PEP 506 uses the IP-Queue program 510 to access TCP frames, thereby, allowing the PEP to operate in the user space, while at the same time being able to access packets.

The Netfilters API provides a number of locations at which packet rules can be applied. The following provides an illustrative list of locations where firewall rules can be applied.
1. PRE-ROUTING: This location provides access to all incoming packets.
2. LOCAL IN (INPUT): Packets destined to the local host will not be routed, therefore this is the last point to access them before they are passed to a user space application.
3. IP FORWARD: This point is before the routing decision has been made.
4. POST ROUTING: After the routing decision has been made.
5. LOCAL OUT (OUTPUT): Last point before packets are transmitted. Provides access to all out going packets.

The location to apply these rules depends on the type of packets the PEP intends to intercept. If the IP-ABR PEP is located on an end host and is used to manage local TCP flows, then both the OUTPUT and INPUT channels are accessed. If the PEP is installed up on a router and is used to manage “all” TCP flows passing through it, only the OUTPUT channel needs to be accessed. Various predefined rules exist to instruct the firewall subsystem on how to process a packet. Simple rules such as ACCEPT and DROP are used to handle packets. To redirect packets to the IP-ABR PEP one can make use of the QUEUE rule.

The QUEUE rule is used in conjunction with the IP-Queue module. The QUEUE rule instructs the kernel to redirect the packet to a user space application for processing. However, the application exists in the user space memory and the packet exists in the kernel space memory and access to kernel space it restricted to the kernel and kernel modules. To overcome this restriction the packet is temporarily “copied” into user space by the IP-Queue module. The packet is queued in user space so that an application such as the IP-ABR PEP can access it. Once the packet is processed it is passed by the kernel with a “verdict” issue. The verdict instructs the kernel on how to handle the packet. More specifically, the verdict allows the application to instruct the kernel to either drop or allow the packet.

After the window field in the ACK header is modified by the IP-ABR PEP one of the last things that needs to be done before transmitting the packet, is to re-compute any packet header checksums. The IP header checksum does not need to be updated, since the IPABR does not modify IP header fields. However, the TCP checksum needs to be recomputed, due to modification of the window field in the header. Unlike the IP header checksum the TCP checksum covers both the TCP header and the payload. This checksum is computed by padding the data block with 0, so that it can be divided into 16-bit blocks and then computing the ones-complement sum of all 16 bit blocks.

Computing the checksum over the entire length of the TCP frame, for every ACK the IPABR PEP modifies, is computationally expensive. However, if only a single field changes, the checksum can be recomputed incrementally as described in RFC 1624, for example. To compute a new checksum by incrementally updating the checksum one adds the difference of the 16-bit field that has changed to the existing checksum. Incrementally updating a checksum is well known to one of ordinary skill in the art.

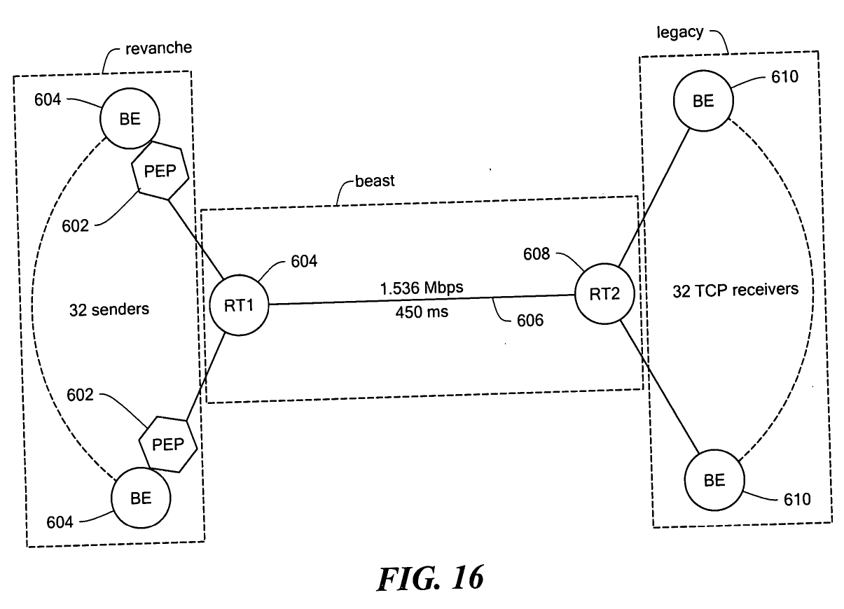

After implementing an IP-ABR PEP as described above, the PEP performance was evaluated in reducing throughput variability, decreasing packet loss, lowering delays and jitter. FIG. 16 shows an exemplary network topology 600 for a test bed for the illustrative IP-ABR implementation. IP-ABR PEPs 602 are coupled to a first router 604 and located proximate best effort senders 604. The first router 604 is coupled via a link 606 to a second router 608 to which various best effort receivers 610 are coupled.

The test network had a bandwidth delay product similar to that of a satellite IP network. In the various tests, regular TCP service performance was compared to the inventive IP-ABR service implemented with the prototype PEP by comparing metrics such as throughput variability, packet loss and delays. Two different queuing disciplines, drop-tail and Derivative Random Drop (DRD) were used.

The test network topology is similar to that used in the NS simulations conducted earlier. However, instead of using multiple end hosts, one for each TCP flow, in this topology there are two end hosts on either end of a satellite link. The end hosts are connected to a satellite link via a router; the link between the end hosts and the router is 100 Mbps Ethernet link. The bandwidth of the satellite link is that of a T1 link (i.e., 1.536 Mbps), therefore it serves as a bottleneck link.

One challenge with implementing this test bed, is that it calls for connecting the hosts 604, 610 over a satellite link, which is not is not easily accessible in the lab environment. However, instead of using an actual satellite link to connect the hosts, a network emulator was used. A NISTnet network emulator developed by the National Institute of Standards and Technology was used. The NISTnet emulator can emulate link delays and bandwidth constraints. The NISTnet emulator also provides various queuing disciplines such as DRD and ECN. The NISTnet software is available for the Linux operating system at the NIST website http://www.antd.nist.gov/tools/nistnet/. The NISTnet emulation program is a Linux kernel module.

The NISTnet emulator is usually deployed on an intermediate router between two end hosts. Once installed, the emulator replaces the normal forwarding code in the kernel. Instead of forwarding packets as the kernel normally does, the emulator buffers packets and forwards them at regular clock intervals that correspond to the link rates of the emulated network. Similarly, in order to emulate network delays, incoming packets are simply buffered for the period of the delay interval. The NISTnet emulator acts only upon incoming packets and not upon outgoing packets, therefore, in order to properly emulate a network protocol such as TCP, which has bidirectional traffic flow, the emulator should be configured for traffic flowing in both directions as shown in Table 1 below.

TABLE 1
Emulator Configuration

| Source | Destination | BW Bytes/sec | Delay ms |
|---|---|---|---|
| Sender | Receiver | 192000 | 450 |
| Receiver | Sender | 192000 | 450 |

To emulate a network with specific bandwidth and delay characteristics, one can specify the IP address of the source and destination end hosts and the bandwidth and delay of the emulated link between the end hosts. The NISTnet emulator also allows either of two queuing disciplines to be specified: Derivative Random Drop (DRD) or Explicit Congest Notification (ECN).

Note that in FIG. 16 there are two routers 604,608 on either end of the satellite link 606 where the first router 604 is the router closer to the sender and the second router 608 is the router closer to the receiver.

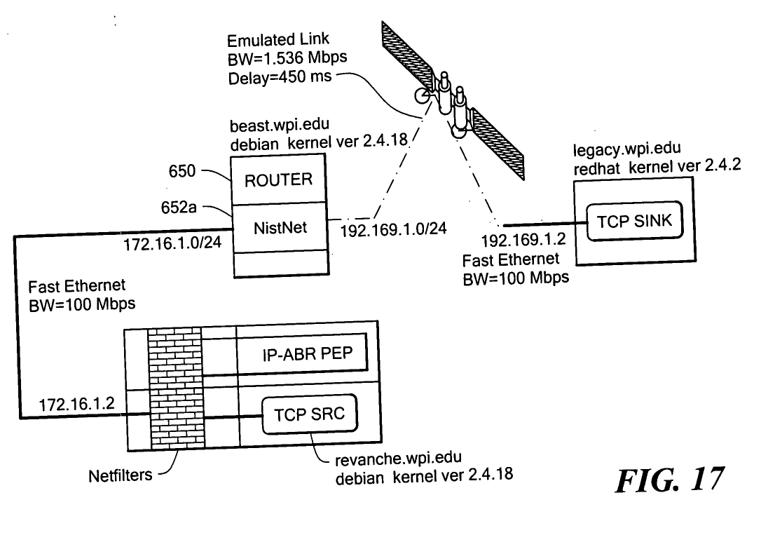

In the test configuration of FIG. 17 a single router 650 is used instead of two routers. The single router in the middle is configured to emulate the bandwidth constraint of the satellite link, but is not configured to emulate delays. However, each end host has a NISTnet emulator 652 that is configured to emulate the satellite link delay for incoming packets. In this configuration the single router in the middle appears to be RT1 (FIG. 16) to the sender and RT2 to the receiver. Because congestion does not occur on the router located on the far side of the link, it is not necessary to emulate the routing queue of RT2.

In order to emulate the test environment shown in FIG. 16, three machines where used: three PCs with the Linux operating system. Table 2 details the configuration and purpose of each of the three machines.

TABLE
Test Equipment Configuration

| | revanche. | | |
|---|---|---|---|
| Hostname | ece.wpi.edu | beast.ece.wpi.edu | legacy.ece.wpi.edu |
| Purpose | End Host/TCP | Router | End host/TCP sink |
| | source | | |
| Processor | AMD Athlon MP | AMD Athlon 1.1 | Pentium 2 (400 |
| | 1800+ | GHz | Mhz) |
| OS | Linux (Debian) | Linux (Debian) | Linux (Red Hat 7.3) |
| TCP | NewReno | NewReno | NewReno |
| Version | | | |

Two of the machines served as the end hosts in a TCP connection, and the third machine was used as the router. The end host machines were connected to the router host with a 100 Mbps fast Ethernet LAN. The end host “revanche” acted as a TCP sender and was therefore on the congested side of the link. The IP-ABR PEP also resided upon this host. The NISTnet emulation program was installed on the router box “beast” and is configured to emulate the satellite link bandwidth for traffic going in either direction. The third PC (legacy) is used as the receiver end host. As mentioned previously, each end host also has a NISTnet emulator configured to emulate the delay of the satellite link.

In the tests, multiple TCP flows were created that compete for the bandwidth of the shared bottleneck link. Using the Python programming language, for example, two programs were developed, one for the sender/client side, and, the other for the receiver/server side. The sender side program is used to spawn n concurrent threads. Each thread makes a request for a socket connection from the receiver/server side. When the receiver/server gets this request, it spawns a corresponding thread to service that sender/client. Once the connection is established, the sender will continuously send MSS size blocks of data to the receiver by writing to the socket buffer as fast as possible. By keeping TCP data buffers full, one ensures that each TCP flow competes against each other by trying to gain the maximum possible bandwidth.

Using the test bed configuration described above, IP-ABR performance was compared to TCP performance for various queuing disciplines including drop tail, DRD, and ECN. Parameters for the queuing disciplines can be varied in a manner well known in the art based with the described test set up. Performance of the IP-ABR service was enhanced in throughput variability, packet loss, jitter and delay as compared to TCP service.

In addition to offering enhanced QoS over TCP, the inventive IP-ABR service can also guarantee fair bandwidth usage, which ‘regular’ TCP cannot offer at all. In previous tests, configuration was for the IP-ABR proxy to equally allocate the available bandwidth amongst the flows. The IP-ABR proxy in-band limits the throughput of the flows to a narrow bandwidth range over time. The fairness of this bandwidth division between different flows can be examined. In order to draw a fair comparison of IP-ABR and TCP fairness, data from a drop-tail test was used for which the queue size of 30 packets was used in both cases. From this test data, the flow utilization was estimated over the duration of the test, for which the utilization was normalized to the bandwidth of the satellite link.

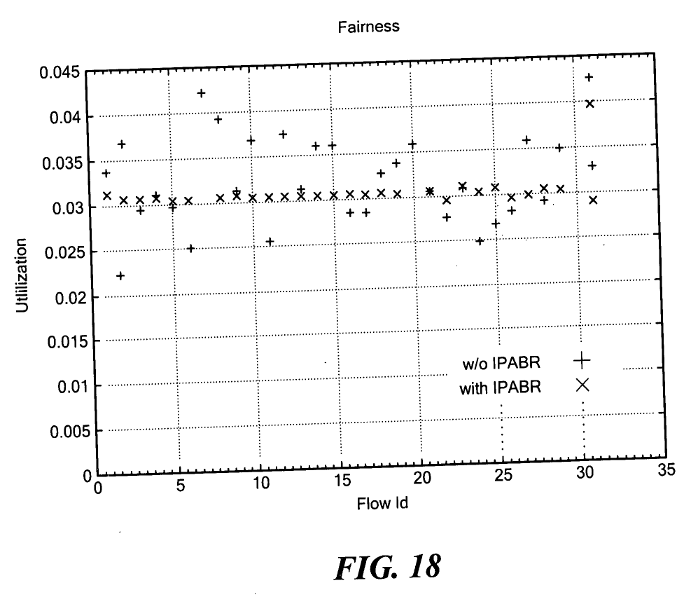

FIG. 18 shows the normalized utilization of each IP-ABR flow and the normalized utilization of each TCP flow. As can be seen the IP-ABR utilization numbers are almost equal, whereas the regular TCP utilization numbers vary widely.

In scenarios described above the IP-ABR proxy distributes bandwidth equally amongst the flows. However, the inventive proxy is also effective in scenarios for which bandwidth is distributed unevenly.

To verify the proxy's effectiveness in creating a weighted distribution of bandwidth we conducted a test. On the bottleneck router a drop-tail queuing discipline was configured with a queue size of 30. The test duration to was set to 480 secs. Using the IP-ABR proxy bandwidth was assigned in the ratio of 1:2:4:8 to 4 groups of flows, each group having 8 flows. This test first verifies that the bandwidth was distributed as desired. In addition to this, it is also verifies that each group of flows exhibits the characteristics of IP-ABR service flows, namely low throughput variation, low delay and low jitter.

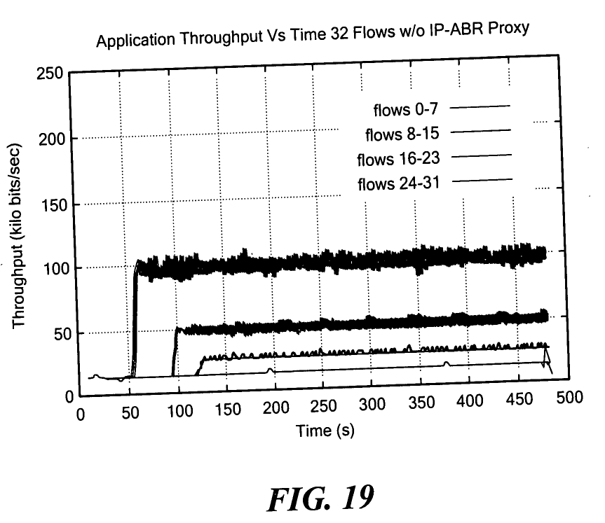

FIG. 19 shows the measured throughput for each of the 32 flows over the duration of the test. It can clearly be seen that the 32 flows are grouped into 4 groups and that the achieved throughput of each group was appropriate for the allocated ratio. In addition, the achieved throughputs display minimal variation.

In another aspect of the invention, an IP flow management mechanism includes route-specified window TCP, which can be referred to as IP-VBR. In a given OS for known TCP implementations, when a TCP socket is allocated, the OS fills in the socket window size from a system default. This default window size is configured by an administrator based on approximations of the local network configuration. However, many networks have multiple gateways and routes to the rest of the Internet, and this single default window size may not provide the flexibility to optimally tune TCP for often-encountered routes and delays.

The default window size is set based upon the route of the data flow so that self-paced behavior is guaranteed. TCP flows from these sources enjoy nearly constant maximum bandwidth and acceptable jitter owing to low throughput variation. In one embodiment, the data flow will not enjoy bandwidth beyond the limit imposed by lowered window sizes, even when additional bandwidth is available. In one particular embodiment, no modifications to TCP are required. To implement this technique, the operating system or application code is modified to use a route-dependent entry in the router table for a connection's receive-window size rather than a system global default value.

In an exemplary embodiment, the inventive IP-VBR router priority class has a priority level between the CBR and BE priorities to separate this traffic from the BE traffic that would otherwise disrupt the window-induced self-pacing. Modifying the OS permits all existing applications to use this new service without alteration, but modifying the application allows new applications to enjoy this service regardless of the OS in use.

Users of the IP-VBR service are assigned a priority for class based queuing (CBQ) between that of CBR sources and classic BE sources to ensure these sources become self-pacing since their traffic would be subjected to the congestion, queuing delays and bandwidth variations induced by the behavior of classic, uncontrolled BE sources sharing the same paths.

IP-VBR includes the use of Route Specified Windows (RSW) to provide guaranteed bandwidth and low jitter for compliant hosts without modification of TCP semantics and implementations. A determination of the optimal window size per route includes a number of factors including how many hosts will share a network link. The number of hosts sharing a link may vary widely, such as in ad-hoc networks with roaming users.

IP-VBR can provide high QoS (such as obtained by IP-ABR) by having an agent (either human or automated) establish the round-trip propagation delays between various sites of primary interest and “write” the values of TCP window sizes that should be used when making a connection to these sites into the router table of the end point computers. Thus, without proxies and without changing the basic protocols for TCP/IP communications, each high QoS-stable bandwidth would be established upon creation of that connection.

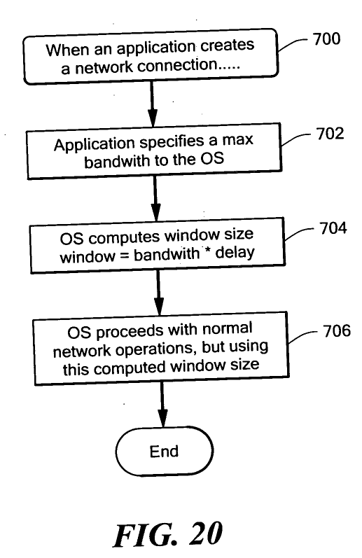

FIG. 20 shows an exemplary sequence of steps to implement IP-VBR. At machine startup, the round trip delay to certain destinations and networks is measured. In step 700, an application creates a network connection. In step 702, the application specifies a maximum bandwidth request to the OS. The OS computes the window size as window=bandwidth×delay in step 704. In step 706, the OS proceeds with normal network operations using the computed window size.

Security considerations may be needed since the bandwidth limits imposed by route defaults are enforced at the end system's operating system level. If the OS is configured incorrectly or tampered with, it may inject excessive traffic and prevent delivery of the QoS implied by this service to other clients.

In another aspect of the invention, a proxy includes segment caching. TCP sequentially numbers data segments. The RTO (round trip time-out) caused flow variation on long-delay links (like satellites) can be ameliorated by placing a PEP on the destination side of these links. The router caches data segments, and when it sees old or duplicate ACKs for a segment in its cache, it may delete the duplicate ACK and retransmit the cached segment. Another PEP function may detect packets lost upstream of their link from sequence number discontinuity and use out-of-band signaling to request resends of the missing sequences from cooperating upstream PEPs. This strategy of caching and resending segments may be used with many protocols using sequence numbers including IPsec.

While the invention is primarily shown and described in conjunction with certain protocols, architectures, and devices, it is understood that the invention is applicable to a variety of other protocols, architectures and devices without departing from the invention.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

1. A method of managing data flows in a network, comprising:
dynamically determining bandwidth usage and available bandwidth for IP-ABR service data flows;
dynamically allocating a portion of the available bandwidth to the IP-ABR data flows;
receiving respective bandwidth requests from network hosts;
determining an optimal window size for a sender host based upon bandwidth allocated for the data flow and a round trip time of a segment to provide self-pacing of the data flow.
